(19) United States
(12) Patent Application Publication
(10) Pub. No.: US 2017/0123629 A1
(43) Pub. Date: May 4, 2017

(54) ICON SEQUENCING METHOD AND DEVICE FOR INTELLIGENT TELEVISION DESKTOP

(71) Applicants: Le Holdings (Beijing) Co., Ltd., Beijing (CN); Le Shi Zhi Xin Electronic Technology (Tianjin) Limited, Tianjin (CN)

(72) Inventor: Hui Zhao, Tianjin (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/240,730

(22) Filed: Aug. 18, 2016

Related U.S. Application Data
(63) Continuation of application No. PCT/CN2016/086618, filed on Jun. 21, 2016.

(30) Foreign Application Priority Data
Nov. 2, 2015 (CN) 201510735929.3

(51) Int. Cl. G06F 3/0481; H04N 21/431; G06F 3/0488; G06F 3/0482; G06F 9/44

(52) U.S. Cl. CPC G06F 3/04817; G06F 3/0482; G06F 9/4443; G06F 3/0488; H04N 21/4312

(57) ABSTRACT

Disclosed are an icon sequencing method for an intelligent television desktop and an electronic device. The method includes: recording a number of times of clicking each icon by a user into a counter corresponding to each icon; arranging location parameters of all icons in a descending order according to the number of clicking times of each counter; and displaying each icon in a relevant location on the intelligent television desktop according to the location parameter of each icon. The present disclosure also discloses an electronic device for icon-sequencing device on an intelligent television desktop, wherein the electronic device comprises at least one processor; and a memory communicably connected with the at least one processor for storing instructions executable by the at least one processor.

### CROSS REFERENCE TO RELATED APPLICATIONS

This application is a continuation of International Application No. PCT/CN2016/086618, filed on Jun. 21, 2016, which is based upon and claims priority to Chinese Patent Application No. 201510735929.3, filed on Nov. 2, 2015, the entire contents of which are incorporated herein by reference.

### TECHNICAL FIELD

The disclosure relates to a graphic user interface technology, and more particularly, to an icon sequencing method and device for an intelligent television desktop.

### BACKGROUND

A full-video TV desktop of an intelligent television may act as a user-default operating desktop. By using the desktop, each application can be quickly started. The desktop may be designed as a page for arranging application icons in a matrix of m*n (i.e., m rows and n columns). If the application icons cannot be arranged in one page, another page can be added for arranging the application icons, and all the pages can be quickly switched, wherein the icons arranged in the front by default are those of built-in applications of a system.

In view of user needs, a function for sequencing the application icons is required to be strengthened. Currently, manual sequencing on the application icons has been already realized, i.e.: the user can move any icon to a certain location or into a certain folder as needed.

However, some icons are clicked by the user too many times, and some icons are clicked by the user too few times. At present, there is no icon sequencing method for automatic sequencing according to the frequency of clicking the icons by the user.

### SUMMARY

The present invention provides a method and device capable of re-sequencing the icons according to the frequency of clicking desktop icons by the user.

According to a first aspect, the present disclosure provides an icon sequencing method for an intelligent television desktop. The method includes: recording a number of times of clicking each icon by a user into a counter corresponding to each icon; arranging location parameters of all icons in a descending order according to the number of clicking times of each counter; and displaying each icon in a relevant location on the intelligent television desktop according to the location parameter of each icon.

According to a second aspect, the present disclosure also provides an electronic device icon-sequencing on an intelligent television desktop, wherein the electronic device includes: at least one processor; and a memory communicably connected with the at least one processor for storing instructions executable by the at least one processor, wherein execution of the instructions by the at least one processor causes the at least one processor to record a number of times of clicking each icon by a user into a counter corresponding to each icon; arrange location parameters of all icons in a descending order according to the number of times of clicking each counter; and display each icon in a relevant location on the intelligent television desktop according to the location parameter of each icon.

According to a third aspect, the present disclosure provides a non-transitory computer-readable storage medium storing executable instructions that, when executed by an electronic device with a touch-sensitive display, cause the electronic device to: record a number of times of clicking each icon by a user into a counter corresponding to each icon; arrange location parameters of all icons in a descending order according to the number of clicking times of each counter; and display each icon in a relevant location on the intelligent television desktop according to the location parameter of each icon.

Relative to the prior art, by adopting the technical solution of the present invention, automatic sequencing is performed according to the frequency of clicking the icons by the user. Whenever an automatic sequencing function is started, the locations of desktop application icons are readjusted according to the frequency, which is convenient for the user to use a desktop of an intelligent device, so that the application icons with higher frequency can be arranged in the front, thereby increasing the speed of starting the applications for the user.

### BRIEF DESCRIPTION OF THE FIGURES

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of an icon sequencing method for an intelligent television desktop according to an exemplary embodiment of the present disclosure;

FIG. 2 is a system structure diagram of an icon sequencing device for an intelligent television desktop in an exemplary embodiment of the present disclosure; and

FIG. 3 is a system structure diagram of an electronic device for achieving an icon sequencing function on an intelligent television desktop according to an exemplary embodiment of the present disclosure.

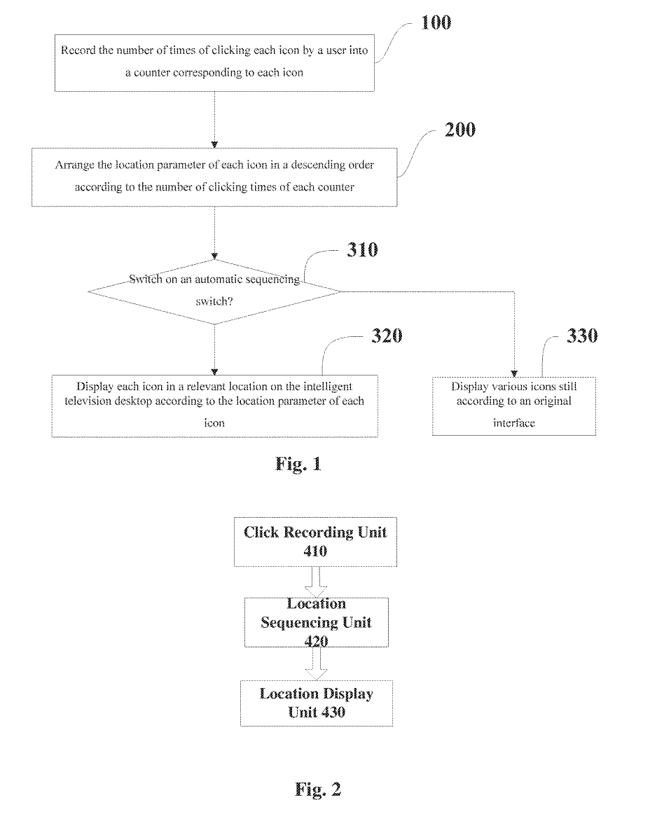

### DETAILED DESCRIPTION

The following clearly describes the technical solutions in the embodiments of the present invention with reference to the accompanying drawings in the embodiments of the present invention. The described embodiments are merely some but not all of the embodiments of the present invention.

FIG. 1 is a flow chart of an icon sequencing method for an intelligent television desktop according to a first exemplary embodiment of the present invention. As shown in FIG. 1, the method includes the following steps.

In step 100, a number of times of clicking each icon by a user is recorded into a counter corresponding to each icon. In an intelligent television adopting an android operating system, icons of the full-video TV desktop mainly include five types: icons of built-in applications of programs, icons of system applications, icons of folders with built-in applications, icons of recommended application folders, and icons of recommended application icons. The user clicks respective icons based on various intentions (e.g., system setting, video playing, etc.).

One counter may be arranged for each icon. In the present invention, an integer-type variable mClickRepeatCount is added in an Appinfo class corresponding to each icon, for recording the clicking frequency of the user. Whenever the user clicks the icons once, the integer-type variable regarded as the counter is added by 1. Because the number of click times of the user is only increased but cannot be decreased, the accumulated number of the counter is always increased generally.

It can be known from the above introduction that a click action of the user can be the click for a certain application or the click for a certain folder. In an embodiment of the present invention, the number of click times is recorded regardless of the click for the application or the click for the folder. In this embodiment, when an icon is a multi-level folder, the click on each level of the folder will mean that the number of click times on the icons is accumulated. That is, a plurality of levels in one folder of an icon share one counter. For example, when a first level of the folder is clicked, the counter is added by 1; after clicking and entering the first level of the folder, if another level of the folder still exists inside and the user clicks and enters the second level of the folder, the counter is added by 1 again; after entering the second level of the folder, if the user clicks one of embedded applications, the counter is added by 1 once more.

In step 200: the location parameters of all icons are arranged in a descending order according to the number of clicking times of each counter.

In step 300: all icons are displayed in respective locations on the intelligent television desktop according to the location parameter of each icon.

In the android system, data structures corresponding to the above-mentioned five types of icons are Appinfo classes, but various marks are added in the classes for different types of icons for showing distinction. The Appinfo class corresponding to each icon has an index variable which indicates the location of each icon in an interface. For example, the index variable contains location coordinates (m, n) arranged on a display interface in a matrix of M*N array. When the icons on the desktop are rearranged, the index variable re-determines the location coordinates according to the value of an Int type of variable, and arranges the location coordinates on the desktop in a descending order of the number of click times.

In one exemplary embodiment, the display interface of the intelligent television contains four icons (A, B, C and D) and the four icons are arranged in accordance with 2*2, wherein initial locations of the four icons are: the icon A is located on the first row and the first column, i.e., the location coordinate (1, 1); the icon B is located on the first row and the second column, i.e., the location coordinate (1, 2); the icon C is located on the second row and the first column, i.e., the location coordinate (2, 1); and the icon D is located on the second row and the second column, i.e., the location coordinate (2, 2). After operation for a certain period, the numbers of click times in the counters corresponding to the four icons are respectively: 150 times for the icon A, 60 times for the icon B, 170 times for the icon C and 65 times for the icon D. Then the icons are arranged in a descending order of the number of click times: C, A, D and B. Therefore, the regained coordinates of the four icons on a screen are arranged: C(1, 1), A(1, 2), D(2, 1) and B (2, 2). In this embodiment, if the icons are arranged in a matrix with multi-row and multi-column, in order to ensure that the user uses the desktop icons of the intelligent television more conveniently, the icons with larger number of click times are located more closer to an upper left side of the screen. If there are a larger number icons, the icons are arranged in a plurality of pages, and the icons with larger number of click times are located in pages on the front. In another embodiment, the above four icons can also be arranged in one row on a bottom side or a top side of the intelligent television, or in one column on a left side or a right side; and after arranged in a descending order of the number of click times, the icons can be arranged in an order from left to right or from top to bottom.

In a second embodiment, step 300 includes: in step 310, detecting an automatic sequencing switch value; and in step 320, displaying each icon in a respective location on the intelligent television desktop according to location parameters of each icon when the automatic sequencing switch value is ON. In this embodiment, in a desktop setting class DesktopSettings, a parameter is added for making a distinction whether or not the automatic sequencing function is ON. The parameter can be set by the user. When the user switches on the automatic sequencing switch value through a system setting function, the display interface sequences the displayed icons once according to the recorded number of click times of each icon, and displays all icons in locations where the icons are re-sequenced. If the automatic sequencing switch value is OFF, all icons are still displayed in the original arrangement on the interface in step 330.

In a third embodiment, the method also includes: zero-clearing the counters every a predetermined period. Because the number of click times of the user is only increased but cannot be decreased, the number of click times in the counters is continuously increased. If the number in the counters is not zero-cleared, result accuracy would be degraded over a long time. In another embodiment, after an application is unloaded or reinstalled, the number of click times on the application is zero-cleared, while in this embodiment, the counters are zero-cleared every predetermined period, so as to record the recent behavior of the user more accurately.

In a fourth embodiment, in order to more accurately acquire the user behavior, the click actions are required to be distinguished. The click actions generally cause two results of downloading and opening an application, wherein opening the application is a user behavior which the present invention will mainly focus on. In step 100: when the click is a download action, the counter does not record the number of click times; and when the click is an opening action, the counter records the number of click times.

Accordingly, a fifth embodiment of the present invention also provides an icon sequencing device 400 for an intelligent television desktop. The device includes a click recording unit 410, a location sequencing unit 420 and a location display unit 430, wherein:

the click recording unit 410 is configured to record the number of times of clicking each icon by a user into a counter corresponding to each icon. In the present invention, an integer type of variable mClickRepeatCount is added in AppInfo class corresponding to each icon for recording the click frequency of the user. Therefore, whenever the user clicks an icon once, the integer type of variable regarded as the counter is added by 1.

The location sequencing unit 420 is configured to arrange the location parameter of each icon in a descending order according to the number of clicking times of each counter. In the present invention, the AppInfo class corresponding to each icon has an index variable which indicates the location of each icon in an interface. For example, the index variable contains location coordinates (m, n) arranged on a display interface in a matrix of M*N array. When the icons on the desktop are rearranged, the index variable re-determines the location coordinates according to the value of the Int type of variable, and arranges the location coordinates on the desktop in a descending order of the number of click times.

Those skilled in the art should understand that the above click recording unit 410 and the location sequencing unit 420 can be realized through different program codes or through different algorithms.

The location display unit 430 is configured to display each icon in a respective location on the intelligent television desktop according to the location parameter of each icon.

In a sixth embodiment, the icon sequencing device includes an automatic sequencing switch unit, and the automatic sequencing switch unit is configured to set an automatic sequencing switch value and displaying each icon in a respective location on the intelligent television desktop according to the location parameter of each icon when the location display unit detects that the automatic sequencing switch value is ON. In an exemplary embodiment, in AsyncCorizeView classes responsible for all View loading, if the automatic sequencing function is opened, the location of Index is recalculated according to mClickRepeatCount of an application; if the mClickRepeatCount values are identical, the icons are calculated in a descending order in accordance with the locations corresponding to an original Index, and the pages are reloaded.

In a seventh embodiment, the device includes a resetting unit used for zero-clearing the counters every predetermined period.

In an eighth embodiment, in the click recording unit, when the click is a download action, the counter does not record the number of click times; and when the click is an opening action, the counter records the number of click times.

In a ninth embodiment, in the click recording unit, when the icon is a multi-level folder, the click on each level of the folder will mean that the number of click times on the icons is accumulated. In a concrete embodiment, in a folder class FolderPagedViewIcon, the mClickRepeatCount variable is also set at the place of applying “open”, for recording the number of click times on the folder. Every time the folder is clicked, mClickRepeatCount is correspondingly added by 1. In this way, the user can capture click behaviors of the applications inside and outside the folder.

The above units for realizing the functions are realized through a corresponding software module, a related CPU, a memory, an I/O interface, etc.

A tenth embodiment of the present disclosure provides a nonvolatile computer-readable storage medium which stores executable instructions, wherein the above icon sequencing methods for an intelligent television desktop according to any one embodiment as above can be performed by the executable instructions.

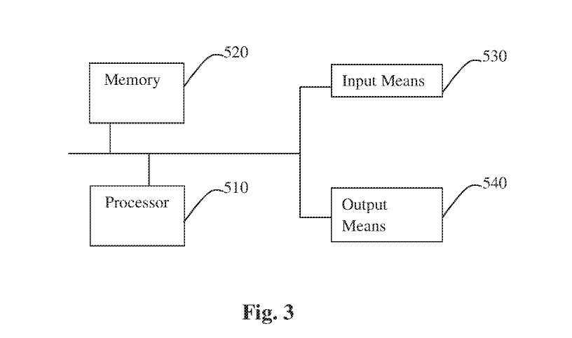

FIG. 3 is a hardware structure diagram of an electronic device for performing the icon sequencing method for an intelligent television desktop according to an eleventh embodiment of the present disclosure.

As shown in FIG. 3, the electronic device includes one or more processors 510 and a memory 520. FIG. 3 takes one processor 510 as an example.

The electronic device for performing the icon sequencing method for an intelligent television desktop may further include an input means 530 and an output means 540.

The processor 510, the memory 520, the input means 530 and the output means 540 may be connected via a bus or in other ways. In FIG. 3, these elements are connected via a bus.

The memory 520 can be used as a nonvolatile computer-readable storage medium, which can store a nonvolatile software program, a nonvolatile computer-executable program, and respective modules. For example, the medium stores program instructions/modules for performing the icon sequencing method according to the embodiments of the present disclosure, such as the click recording unit 410, the location sequencing unit 420 and the location display unit 430. The processor 510 executes the nonvolatile software program, instructions and/or modules stored within the memory 520, so as to perform several functional applications and data processing, particularly, perform the icon sequencing method for an intelligent television desktop according to the above embodiments as above.

The memory 520 may include a storage program zone and a storage data zone. The storage program zone may store an operating system and at least one application program for achieving respective functions. The storage data zone may store data created according to the usage of the icon sequencing device. In addition, the memory 520 may further include a high speed random access memory and a nonvolatile memory, e.g. at least one of a disk storage device, a flash memory or other nonvolatile solid storage device. In some embodiments, the memory 520 may include a remote memory remotely located relative to the processor 510, and this remote memory may be connected, via a network, to the icon sequencing device for an intelligent television desktop. For example, the network includes but is not limited within internet, intranet, local area network, mobile communication network and any combination thereof.

The input means 530 can receive an input user-clicking, and generate a signal input associated with a user setting and a functional controlling of the icon sequencing device. The output means 540 may include a display device such as a displaying screen, for displaying results of icon-sequencing and related information.

One or more storage modules are stored within the memory 520. When said one or more storage modules are operated by one or more processors 510, the icon sequencing method for an intelligent television desktop of the above embodiments is performed.

The products as above-mentioned may perform methods provided by the embodiments of the present disclosure, have functional modules for performing the methods, and achieve respective beneficial effects. For those technical details which are not mentioned in this embodiment, please refer to the methods provided by the embodiments of the disclosure.

The electronic device of the embodiment of the present disclosure may be constructed in several forms, which include but are not limited within:

(1) mobile communication device: this type of terminal has a function of mobile communication for main propose of providing a voice/data communication. This type of terminal includes: a smartphone (e.g. iPhone), a multimedia mobile phone, a feature phone, a low-end cellphone and so on;

(2) ultra mobile personal computer device: this type of terminal belongs to a personal computer which has a computing function and a processing function. In general, this type of terminal has a networking characteristic. This type of terminal includes: PDA, MID, UMPC and the like, e.g. iPad;

(3) portable entertainment device: this type of device can display and play multimedia contents. This type of device includes an audio/video player (e.g. iPod), a handheld game console, an electronic book, an intelligent toy, and a portable vehicle navigation device;

(4) server: the server provides a computing service. The construction of a server includes a processor, a hard disk, an internal memory, a system bus and so on, which is similar to the construction of a general computer but can provide more reliable service. Therefore, with respect to processing ability, stability, reliability, security, extendibility and manageability, a server has to meet a higher requirement; and

(5) other electronic devices having data interchanging functions.

Those skilled in the art should understand that the embodiments of the present disclosure can provide a method, system or computer program product. The present disclosure can adopt a form of a full hardware embodiment, a full software embodiment or an embodiment combining software and hardware. The programs can be stored in a computer-readable storage medium. The programs in execution can include the flows of the embodiments of above methods, wherein the storage medium can be: a disk, a CD, a read-only memory (ROM) or a random access memory (RAM), etc.

The present disclosure is described with reference to flow charts and/or structural block diagrams according to the method, device and the computer program product in the embodiments of the present disclosure. It should be understood that each flow and/or block in the flow charts and/or structure block diagrams and a combination of the flows and/or blocks in the flow charts and/or structure block diagrams can be realized through computer program instructions. The computer program instructions can be provided for a processor of a general-purpose computer, a special-purpose computer, an embedded processor, or other programmable data processing devices to generate a machine, so that a device for realizing designated functions in one or more flows of the flow charts and/or one or more blocks of the block diagrams is generated through the instructions executed by the processor of the computer or other programmable data processing devices.

The above implementation steps and methods only express several embodiments of the present disclosure, which are described more specifically and in details, but cannot be thus understood as a limitation to the patent scope of the present disclosure. It should be noted that those having ordinary skills in the art of the disclosure may also make many modifications and improvements without departing from the conceive of the disclosure which shall all fall within the protection scope of the disclosure. Therefore, the patent protection scope of the present disclosure shall be subjected to the appended claims.

What is claimed is:

1. An electronic device for icon-sequencing on an intelligent television desktop, wherein the electronic device comprises:
at least one processor; and
a memory communicably connected with the at least one processor for storing instructions executable by the at least one processor,
wherein execution of the instructions by the at least one processor causes the at least one processor to record a number of times of clicking each icon by a user into a counter corresponding to each icon; arrange location parameters of all icons in a descending order according to the number of times of clicking each counter; and display each icon in a relevant location on the intelligent television desktop according to the location parameter of each icon.

2. The electronic device according to claim 1, wherein said processor is further configured to set an automatic sequencing switch value, and display each icon in a relevant location on the intelligent television desktop according to the location parameter of each icon when the location display unit detects that the automatic sequencing switch value is “ON”.

3. The electronic device according to claim 1, wherein said processor is configured to zero-clear the counters every predetermined period.

4. The electronic device according to claim 2, wherein said processor is configured to zero-clear the counters every predetermined period.

5. The electronic device according to claim 1, wherein the processor is further configured so that when the click is a download action, the counter does not record the number of click times; and when the click is an opening action, the counter records the number of click times.

6. The electronic device according to claim 2, wherein the processor is further configured so that when the click is a download action, the counter does not record the number of click times; and when the click is an opening action, the counter records the number of click times.

7. The electronic device according to claim 1, wherein the processor is further configured so that when the icon is a multi-level folder, the click on each level of the folder means that the number of click times on the icon is accumulated.

8. The electronic device according to claim 2, wherein the processor is further configured so that when the icon is a multi-level folder, the click on each level of the folder means that the number of click times on the icon is accumulated.

9. An icon sequencing method for an intelligent television desktop, wherein the method comprises:
recording a number of times of clicking each icon by a user into a counter corresponding to each icon;
arranging location parameters of all icons in a descending order according to the number of clicking times of each counter; and
displaying each icon in a relevant location on the intelligent television desktop according to the location parameter of each icon.

10. The method according to claim 9, wherein the step of displaying each icon in the relevant location on the intelligent television desktop according to the location parameter of each icon comprises: detecting an automatic sequencing switch value, and displaying each icon in the relevant location on the intelligent television desktop according to the location parameter of each icon when the automatic sequencing switch value is “ON”.

11. The method according to claim 9, wherein the method further comprises:
zero-clearing the counters every predetermined period.

12. The method according to claim 9, wherein the step of recording a number of times of clicking each icon by the user into the counter corresponding to each icon comprises: when the click is a download action, the counter does not record the number of click times; and when the click is an opening action, the counter records the number of click times.

13. The method according to claim 9, wherein when the icon is a multi-level folder, the click on each level of the folder means that the number of click times on the icon is accumulated.

14. A non-transitory computer-readable storage medium storing executable instructions that, when executed by an electronic device with a touch-sensitive display, cause the electronic device to:
record a number of times of clicking each icon by a user into a counter corresponding to each icon; arrange location parameters of all icons in a descending order according to the number of clicking times of each counter; and display each icon in a relevant location on the intelligent television desktop according to the location parameter of each icon.

15. The non-transitory computer-readable storage medium according to claim 14, wherein the step of displaying each icon in the relevant location on the intelligent television desktop according to the location parameter of each icon comprises: detecting an automatic sequencing switch value, and displaying each icon in the relevant location on the intelligent television desktop according to the location parameter of each icon when the automatic sequencing switch value is “ON”.

16. The non-transitory computer-readable storage medium according to claim 14, wherein the method further comprises: zero-clearing the counters every predetermined period.

17. The non-transitory computer-readable storage medium according to claim 15, wherein the method further comprises: zero-clearing the counters every predetermined period.

18. The non-transitory computer-readable storage medium according to claim 14, wherein the step of recording a number of times of clicking each icon by the user into the counter corresponding to each icon comprises: when the click is a download action, the counter does not record the number of click times; and when the click is an opening action, the counter records the number of click times.

19. The non-transitory computer-readable storage medium according to claim 15, wherein the step of recording a number of times of clicking each icon by the user into the counter corresponding to each icon comprises: when the click is a download action, the counter does not record the number of click times; and when the click is an opening action, the counter records the number of click times.

20. The non-transitory computer-readable storage medium according to claim 14, wherein when the icon is a multi-level folder, the click on each level of the folder means that the number of click times on the icon is accumulated.
